(19) United States
(12) Patent Application Publication
(10) Pub. No.: US 2025/0164704 A1
(43) Pub. Date: May 22, 2025

(54) CONNECTOR SYSTEM FOR OPTICAL FIBRES AND ASSEMBLY DEVICE

(71) Applicant: HARTING Electronics GmbH, Espelkamp (DE)

(72) Inventors: Marc GENAU, Luebbecke (DE); Rainer BUSSMANN, Bad Essen (DE)

(21) Appl. No.: 18/837,555

(22) PCT Filed: Feb. 9, 2023
(86) PCT No.: PCT/DE2023/100106

§ 371 Date: Aug. 9, 2024

(30) Foreign Application Priority Data
Feb. 28, 2022 (DE) 10 2022 104 667.2

(51) Int. Cl. G02B 6/38

(52) U.S. Cl. CPC G02B 6/3885; G02B 6/3851; G02B 6/3894; G02B 6/3898

(57) ABSTRACT

A connector system for optical fibers has at least two connectors which can be brought into engagement with one another and which each have at least one connector housing, at least one cable inlet disposed in the connector housing and at least one cover, and which each accommodate at least one fiber receptacle which is introduced at least partially between the connector housing and the cover. The fiber receptacle receives at least two wires of an optical cable, the fiber receptacle being designed with at least one connector region and with at least one coding region. The connector region has at least one wire receptacle for each wire being received and at least one fixing receptacle which is substantially orthogonal to the wire receptacle and into which a wire fixing means for fastening the wires in the fiber receptacle is introduced.

The invention is based on a plug connector for optical fibers according to the preamble of the independent claim 1. The invention is furthermore based on an assembly device for assembling such a plug connector.

Such plug connectors are required for connecting cables with optical fibers, in particular polymer optical fibers. Such cables are mainly used for transmission of data with particularly high data transmission rates. Cables with polymer optical fibers are used in particular in the short-distance data transmission sector.

### PRIOR ART

The prior art discloses some plug connectors for connection of optical fibers. Here however, optical fibers are usually connected individually, whereby logically a greater space is required. In particular when polymer optical fibers are used, it is important to maintain as precise as possible a spacing in the connection, e.g. by means of a plug connector. Too great a spacing—here a few microns—leads to a usually undesirably high damping rate. If the connection is a “butt joint”, i.e. fiber end to fiber end, on movements and/or vibrations in operation of a corresponding machine, damage may occur which prevents or suppresses data transmission.

DE 20 2017 100 608 U1 discloses a plug connector having an insulating housing and a circuit board accommodated in the housing. At least one electro-optical converter is mounted on the circuit board. This converter consists of a converter housing with an electro-optical converter accommodated therein. Furthermore, the plug connector has at least one opening for receiving at least one optical fiber, and at least one electrical contact which is in contact with the circuit board. The plug connector suitably has multiple electrical contacts.

The disadvantage with such plug connectors is the use of at least one circuit board and at least one electro-optical converter. Such plug connectors are therefore not, or only to a very limited extent, suitable for simple applications such as e.g. extending a cable comprising multiple polymer optical fibers.

In the priority application to the present application, the German Patent and Trademark Office has researched the following prior art: WO 2003/076997 A1.

### OBJECT

The object of the invention is to offer a simple and safely usable connector system which prevents possible damage to optical fibers, in particular polymer optical fibers. A further object of the invention is to provide an assembly device which is simple to use for such a connector system.

This object is achieved by the subject of the independent claim 1.

Advantageous embodiments of the invention are given in the dependent claims and in the description which follows.

The object is achieved by a connector system for optical fibers, in particular plastics-based optical fibers, having at least two connectors which can be brought into engagement with one another and which each have at least one connector housing, at least one cable inlet arranged in the connector housing and at least one cover, and which each accommodate at least one fiber receptacle which is introduced at least partially between the connector housing and the cover. The fiber receptacle accommodates at least two cores of an optical cable, wherein the fiber receptacle is configured with at least one connector area and with at least one coding area. The connector area has at least one core receptacle for each core to be accommodated, and at least one fixing receptacle which is formed substantially orthogonally to the core receptacle and into which a core fixing is introduced for fastening the cores in the fiber receptacle. The term “plastics-based optical fibers” means in particular polymer optical fibers, also known as POF. A cable inlet may mean both orifices in the connector housing and also elements introduced into and/or formed on the orifices, such as cable screw terminals or sealing elements such as sealing lips. A cover may also be a component which is configured substantially identically to the connector housing and is used together therewith as a connector housing. The coding area of the fiber receptacle may have fixedly formed coding elements. Alternatively, flexibly insertable coding elements are conceivable. The coding area may thus be configured for example as a succession of blind openings and/or passage openings. Coding elements may now be introduced into these openings.

In a further embodiment, the connector system has at least a first connector and at least a corresponding second connector, wherein the first connector accommodates a first fiber receptacle and the second connector accommodates a second fiber receptacle. This embodiment thus allows the use of different types of connectors, so that according to the invention, both so-called hermaphroditic connectors may be used and also male and female connectors proposed by this refinement.

A suitable embodiment proposes that the first fiber receptacle has a first orientation form and the second fiber receptacle has a second orientation form which are brought correspondingly into engagement with one another. The term “orientation form” means shapes which correspond to one another and facilitate and/or simplify a mutual connection. For example, this may be a chamfer which is formed on a spring in order for connection to be brought into engagement with a groove which is possibly also chamfered.

In a refined embodiment, the first orientation form and the second orientation form are formed such that when intermeshing, i.e. in connected state of the connector system, they prevent contact between the accommodated cores, and/or at least the optical fibers present in the cores.

In addition, an embodiment provides that the first orientation form and the second orientation form are formed as intermeshing protrusions in at least partial ring shape.

A further embodiment provides that the coding area is configured for accommodating at least one coding element.

Suitably, an embodiment proposes that the coding area is arranged on the connector area in a plane running orthogonally to the plug-in direction of the connector.

A refined embodiment provides that the fiber receptacle is formed to accommodate at least two polymer optical fibers.

A further object of the invention is to provide an assembly device for assembling a connector system according to the invention. The assembly device according to the invention has a substantially flat base plate, wherein the base plate is formed to accommodate a first connector and a second connector corresponding thereto.

A suitable embodiment of the assembly device provides that the base plate has and/or accommodates at least one coding element corresponding to a coding element of a connector as claimed in claim 1.

An embodiment furthermore provides that the base plate has mounting forms corresponding to the orientation form of a connector, which are suitable for allowing a substantially flush mounting of the fibers present in cores of a cable.

### EXEMPLARY EMBODIMENT

An exemplary embodiment of the invention is illustrated in the drawings and explained in more detail below. In the drawings:

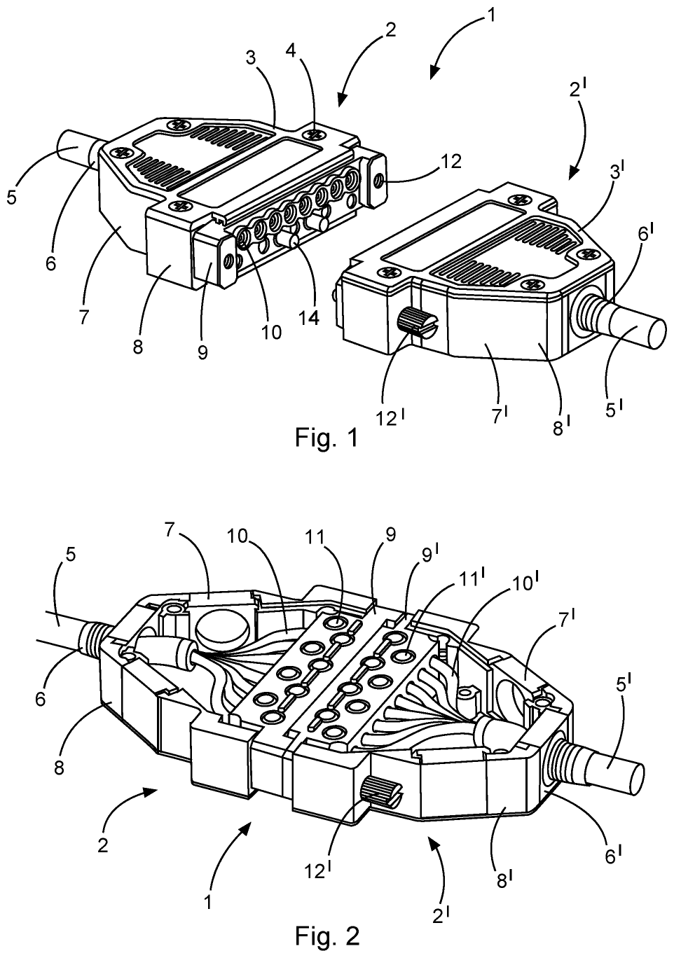

FIG. 1 shows a perspective illustration of a separated plug connector;

FIG. 2 shows a perspective illustration of a connected plug connector without cover;

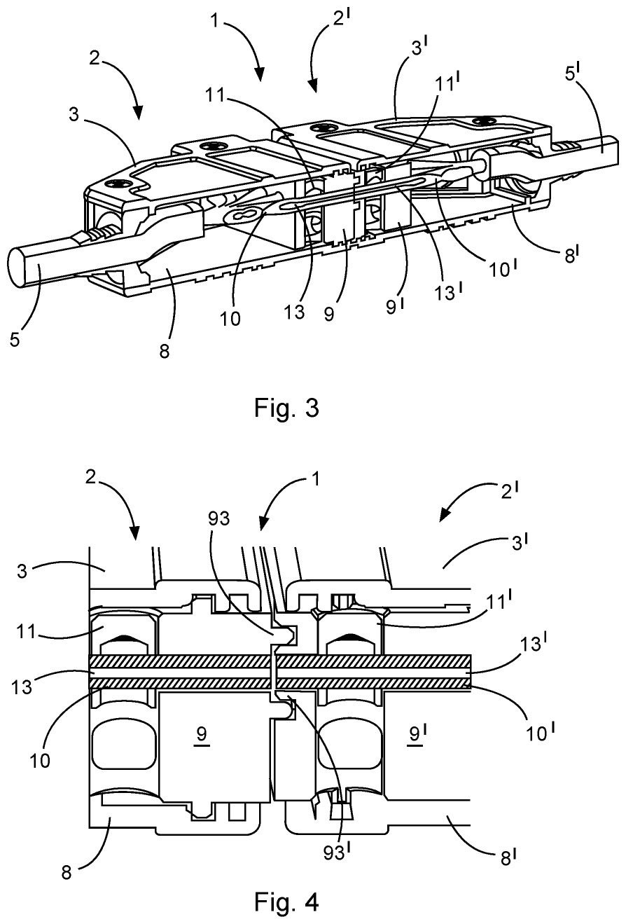

FIG. 3 shows a perspective sectional illustration of a connected plug connector;

FIG. 4 shows a detail view of a connected plug connector;

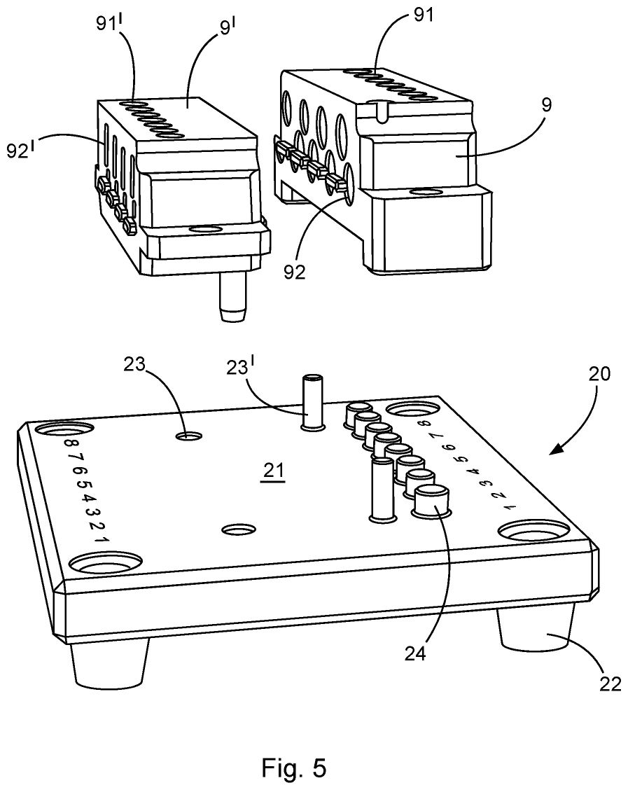

FIG. 5 shows a perspective illustration of an assembly device with two corresponding plug-in areas;

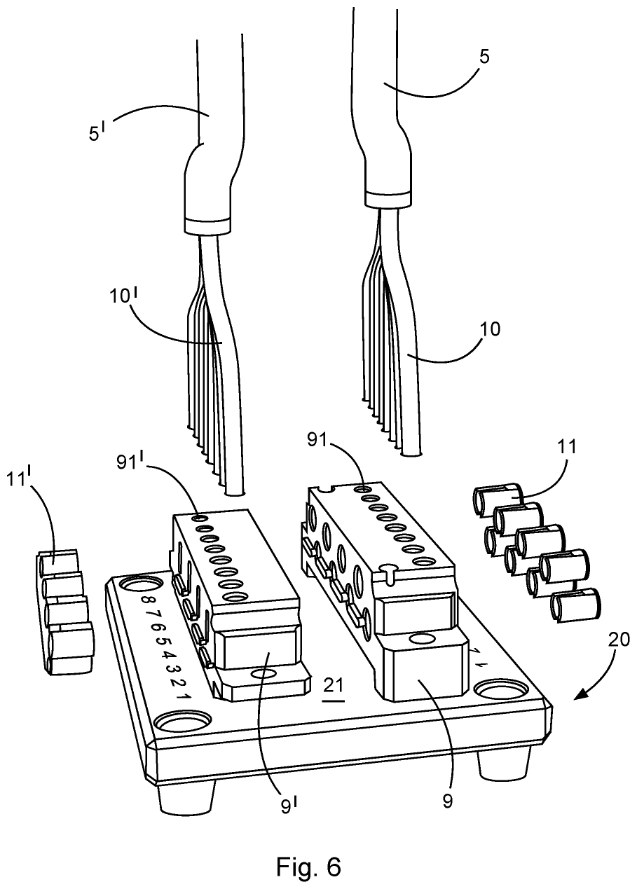

FIG. 6 shows a perspective illustration of an assembly device with two plug-in areas fastened thereto and cables to be introduced therein.

The figures contain partly simplified, schematic illustrations. In some cases, identical reference signs are used for similar but not necessarily identical elements. Different views of the same elements may be scaled differently. Directional data such as for example “left”, “right”, “top” and “bottom” should be understood with reference to the respective figure and may vary in the individual illustrations relative to the object illustrated.

FIG. 1 shows a connector system 1 consisting of two connectors 2 and 2′. The connectors 2 and 2′ are shown in a non-assembled state, separate from one another. The connector system 1 consists of a first connector 2 and a second connector 2′. The connectors 2 and 2′ are in principle designed identically, having a connector housing 8 and 8′, and a cover 3 and 3′ connected thereto by multiple fastening elements 4, cable passages 6 and 6′ which are inserted in cable inlets 7 and 7′ provided in the connector housings 8 and 8′. Fiber receptacles 9 and 9′ are arranged between the connector housings 2 and 2′ and the associated covers 3 and 3′. The fiber receptacles 9 and 9′ differ from one another inasmuch as they intermesh. For example, a fiber receptacle 9 has a groove into which a corresponding spring in the fiber receptacle 9′ is introduced. The fiber receptacles 9 here have multiple core receptacles 91 formed as passage openings, which accommodate the cores 10 of an optical cable 5. Furthermore, the fiber receptacles 9 have connector fastenings 12 and 12′ which are intended to separably connect the connectors 2 and 2′ of the connector system 1′. In the exemplary embodiment shown, a screw connection known from and commonly used in the prior art is shown. The screw connector is shown in use in FIG. 2. Here, the connectors 2 and 2′ of the connector system 1 are guided up to one another and screwed to the threaded openings of the connector 2 with the knurled setscrews of the connector 2′.

FIG. 2 furthermore also shows that the fiber receptacles 9 and 9′ are formed correspondingly to one another and intermesh. Furthermore, thanks to the absence of the cover 3 and 3′, it is clearly shown how the fibers 13 and 13′ accommodated in the cores 10 and 10′ are fixed in the fiber receptacles 9 and 9′. The fixing receptacles 92 formed orthogonally to the core receptacles 91 (more clearly evident in FIGS. 5 and 6) accommodate core fixings 11 and 11′. In the example illustrated, the core fixings 11 and 11′ are formed identically and are not described separately further below. The core fixings 11 here clamp the insulation of the cores 10 without damaging the fibers 13 contained therein.

FIG. 3 shows, by illustration of the connector system 1 in longitudinal section, the interaction of the said components in the connectors 2 and 2′. According to the illustration, the cable 5 enters through a cable passage 6 into a cable inlet 7 of the connector housing 8 which is closed by a cover 3. The cores 10 of the cable 5 are introduced into the fiber receptacle 9, where they are held in position by a core fixing 11. The fibers 13 present in the cores 10 of the cable 5 are connected by the fiber receptacle 9 to the correspondingly designed fiber receptacle 9, so that the fibers 13 and 13′ terminate directly opposite one another.

An optical signal is now transmitted from a fiber 13 to the fiber 13′ without particularly harmful losses. The fibers 13 and 13′ do not touch, so they do not suffer any deterioration or damage due to vibrations or similar movements. The connection of the fibers is clear in the detail extract of FIG. 4. The connectors 2 and 2′ of the connector system 1 are connected, the orientation forms 93 and 93′ of the fiber receptacles 9 and 9′ intermesh but prevent contact between the fibers 13 and 13′.

FIG. 5 and FIG. 6 show an assembly process of the connectors 2 and 2′ according to the invention of the connector system 1. The assembly device 20 firstly allows accommodation of the fiber receptacles 9 and 9′. In the exemplary embodiment shown, the fiber receptacles 9 and 9′ comprise further coding elements which are introduced through or are accommodated by corresponding coding forms 23 and 23′ in the assembly device 20. The assembly device 20 has mounting forms 24 for a first fiber receptacle 9. These mounting forms 24 allow the cores 10 of the cable 5 to be introduced into the fiber receptacle 9 so far that the fibers 13 terminate flush with the orientation form 93 of the fiber receptacle 9. A flat plane of the base plate 21 allows a flush orientation of the fibers 13′ in the orientation forms 93′ of the corresponding fiber receptacle 9′. As soon as a core 10 has been introduced into the core receptacle 91 of the fiber receptacle 9, i.e. up to the stop formed by the base plate 21 and/or the mounting form 24, each core 10 is fixed in its position by at least one core fixing 11 in the fiber receptacle 9. In the embodiment illustrated, the fixing receptacles 92 formed orthogonally to the core receptacles 91 are arranged offset to one another in two planes running parallel with one another. Thus, the fiber receptacle 9 may be made narrower, although slightly deeper.

### LIST OF REFERENCE SIGNS

1 Connector system
2 Connector
3 Cover
4 Fastening element
5 Cable
6 Cable passage
7 Cable inlet
8 Connector housing
9 Fiber receptacle
10 Core
11 Core fixing
12 Connector fastening
13 Fiber
14 Coding element
20 Assembly device
21 Base plate
22 Foot
23 Coding form
24 Mounting form
91 Core receptacle
92 Fixing receptacle
93 Orientation form

1. A connector system for optical fibers, in particular plastics-based optical fibers, having at least two connectors configured to be brought into engagement with one another and which each of the at least two connectors have at least one connector housing, at least one cable inlet arranged in the connector housing and at least one cover, and which each of the at least two connectors are configured to accommodate at least one fiber receptacle which is introduced at least partially between the connector housing and the cover, wherein the fiber receptacle accommodates at least two cores of an optical cable, wherein
the fiber receptacle is configured with at least one connector area and with at least one coding area, wherein the connector area has at least one core receptacle for each core to be accommodated, and at least one fixing receptacle which is formed substantially orthogonally to the core receptacle and into which a core fixing is introduced for fastening the cores in the fiber receptacle.

2. The connector system as claimed in claim 1, wherein
the connector system has at least a first connector and at least a corresponding second connector, wherein the first connector is configured to accommodate a first fiber receptacle and the second connector is configured to accommodate a second fiber receptacle.

3. The connector system as claimed in claim 1, wherein
the first fiber receptacle has a first orientation form and the second fiber receptacle has a second orientation form which are brought correspondingly into engagement with one another.

4. The connector system as claimed in claim 3, wherein
the first orientation form and the second orientation form are formed such that when intermeshing, they prevent contact between the accommodated cores and/or at least the optical fibers present in the cores.

5. The connector system as claimed in claim 3, wherein
the first orientation form and the second orientation form are formed as intermeshing protrusions in at least partial ring shape.

6. The connector system as claimed in claim 1, wherein
the coding area is configured for accommodating at least one coding element.

7. The connector system as claimed in claim 1, wherein
the coding area is arranged on the connector area in a plane running orthogonally to the plug-in direction of the connector.

8. The connector system as claimed in claim 1, wherein
the fiber receptacle is formed to accommodate at least two polymer optical fibers.

9. An assembly device for assembling a connector system as claimed in claim 1, having a substantially flat base plate,
wherein
the base plate is formed to accommodate a first connector and a second connector corresponding thereto.

10. The assembly device as claimed in claim 9,
wherein
the base plate has at least one coding element corresponding to a coding clement of a connector.

11. The assembly device as claimed in claim 9, wherein,
the base plate has mounting forms corresponding to an orientation form of a connector which are suitable for allowing a substantially flush mounting of the fibers present in cores of a cable.

12. The connector system as claimed in claim 2, wherein
the first fiber receptacle has a first orientation form and the second fiber receptacle has a second orientation form which are brought correspondingly into engagement with one another.

13. The connector system as claimed in claim 12, wherein
the first orientation form and the second orientation form are formed such that when intermeshing, they prevent contact between the accommodated cores and/or at least the optical fibers present in the cores.

14. The connector system as claimed in claim 12, wherein
the first orientation form and the second orientation form are formed as intermeshing protrusions in at least partial ring shape.

15. The connector system as claimed in claim 2, wherein
the coding area is configured for accommodating at least one coding element.

16. The connector system as claimed in claim 2, wherein
the coding area is arranged on the connector area in a plane running orthogonally to the plug-in direction of the connector.

17. The connector system as claimed in claim 2, wherein
the fiber receptacle is formed to accommodate at least two polymer optical fibers.

18. An assembly device for assembling a connector system as claimed in claim 2, having a substantially flat base plate,
wherein
the base plate is formed to accommodate a first connector and a second connector corresponding thereto.

19. The assembly device as claimed in claim 18,
wherein
the base plate has at least one coding element corresponding to a coding element of a connector.

20. The assembly device as claimed in claim 18, wherein,
the base plate has mounting forms corresponding to the orientation form of a connector which are suitable for allowing a substantially flush mounting of the fibers present in cores of a cable.
